(19) United States
(12) Patent Application Publication
(10) Pub. No.: US 2022/0266895 A1
(43) Pub. Date: Aug. 25, 2022

(54) STEER BY WIRE TYPE STEERING APPARATUS

(71) Applicant: MANDO CORPORATION, Gyeonggi-do (KR)

(72) Inventors: Sang Chul KU, Seoul (KR); Kwon Ho LEE, Gyeonggi-do (KR); Min Ho PARK, Gyeonggi-do (KR)

(21) Appl. No.: 17/677,925

(22) Filed: Feb. 22, 2022

(30) Foreign Application Priority Data
Feb. 23, 2021 (KR) 10-2021-0024037

(51) Int. Cl. B62D 5/04

(52) U.S. Cl. CPC B62D 5/0469; B62D 5/0421; B62D 5/0409

(57) ABSTRACT

The present embodiments provide a steer by wire type steering apparatus including a first rotating member coupled to the steering shaft to rotate in interlocking, a second rotating member supported on the outer periphery of the first rotating member and rotating in conjunction with the first rotating member when the steering shaft rotates, and a housing in which the first rotating member and the second rotating member are built-in, coupled to the steering column, and the outer circumferential side of the second rotating member is supported on an inner circumferential surface to restrict rotation of the second rotating member.

### CROSS REFERENCE TO RELATED APPLICATION

This application claims priority from Korean Patent Application No. 10-2021-0024037, filed on Feb. 23, 2021, which is hereby incorporated by reference for all purposes as if fully set forth herein.

### TECHNICAL FIELD

The present embodiments relate to a steer by wire steering system, and more particularly, to a steer by wire steering system capable of mechanically stopping the steering wheel from rotating further when the rotation of the wheel reaches its maximum point.

### RELATED ART

In general, power steering has been developed and applied to a vehicle steering apparatus to provide convenience in driving operation by assisting a driver's operating force of a steering wheel. Power steering was developed and applied in hydraulic type using hydraulic pressure, electro-hydraulic type using hydraulic pressure and electric power of the motor at the same time, and electric type using only electric power of the motor.

Recently, instead of removing a mechanical connection device such as a steering column or a universal joint or a pinion shaft between the steering wheel and the wheel, the Steer By Wire (SBW) type steering system for steering a vehicle using an electric motor has been developed and applied.

However, in the case of such a steer by wire type steering system, since there is no mechanical connection between the steering shaft and the wheels, the driver's steering wheel rotation can rotate indefinitely, thereby reducing the driver's steering feeling and steering stability.

Therefore, when the rotation of the wheel reaches its maximum point (when the steering wheel or the wheel is in a full-turn state in a general steering system), there is a need for research to prevent the steering wheel from rotating any more.

### DETAILED DESCRIPTION OF THE INVENTION

### Technical Problem

The present embodiments provide a steer by wire type steering apparatus capable of increasing a driver's steering feel and steering stability by preventing the steering wheel from mechanically rotating anymore when the rotation of the wheel reaches the maximum point.

In addition, the purpose of the present embodiments is not limited thereto, and other objects not mentioned will be clearly understood by those skilled in the art from the following description.

### Technical Solution

The present embodiments provide a steer by wire type steering apparatus including a first rotating member coupled to the steering shaft to rotate in interlocking, a second rotating member supported on the outer periphery of the first rotating member and rotating in conjunction with the first rotating member when the steering shaft rotates, and a housing in which the first rotating member and the second rotating member are built-in, coupled to the steering column, and the outer circumferential side of the second rotating member is supported on an inner circumferential surface to restrict rotation of the second rotating member.

### Advantageous Effects

According to the present embodiments, there is provided a steer by wire type steering apparatus that increases a driver's steering feel and steering safety by preventing the steering wheel from mechanically rotating any more when the rotation of the wheel reaches the maximum point.

### BRIEF DESCRIPTION OF DRAWINGS

FIG. 1 is a schematic view schematically showing a steer by wire type steering apparatus according to the present embodiments.

FIGS. 2 and 3 are perspective views showing some of the steer by wire steering system according to the present embodiments.

FIGS. 4 and 5 are exploded perspective views showing some of the steer by wire steering system according to the present embodiments.

FIG. 6 is a front view illustrating a process in which rotation is restricted in the steer by wire type steering apparatus according to the present embodiments.

FIGS. 7 to 10 are exploded perspective views showing some of the steer by wire steering system according to the present embodiments.

### MODE FOR CARRYING OUT THE INVENTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

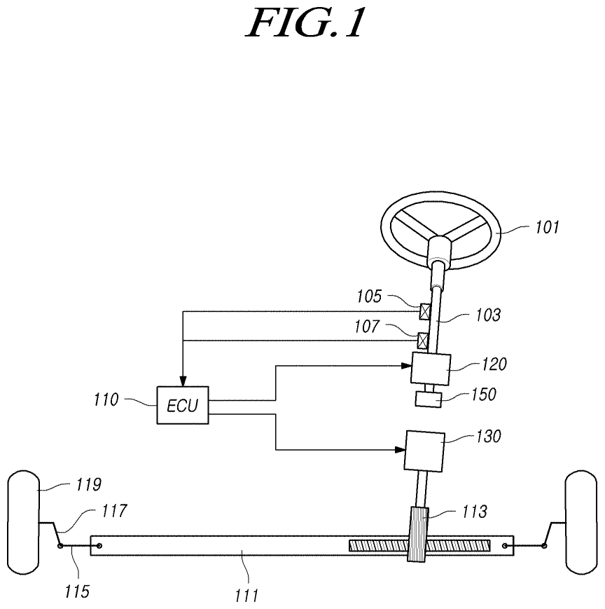

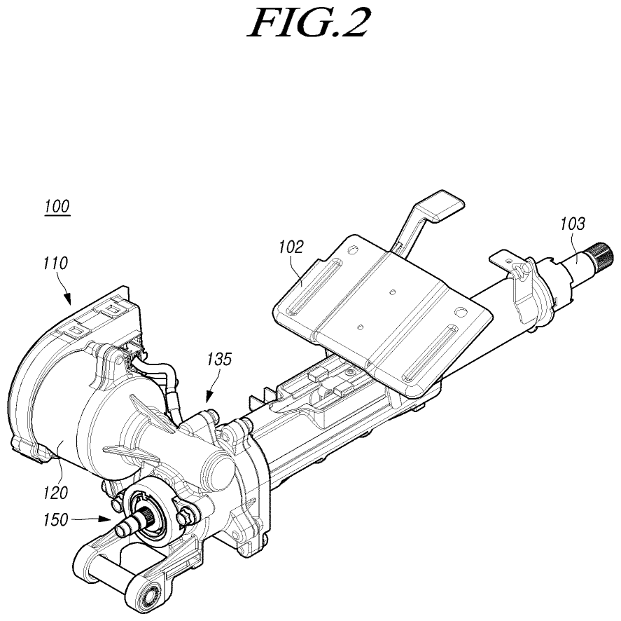

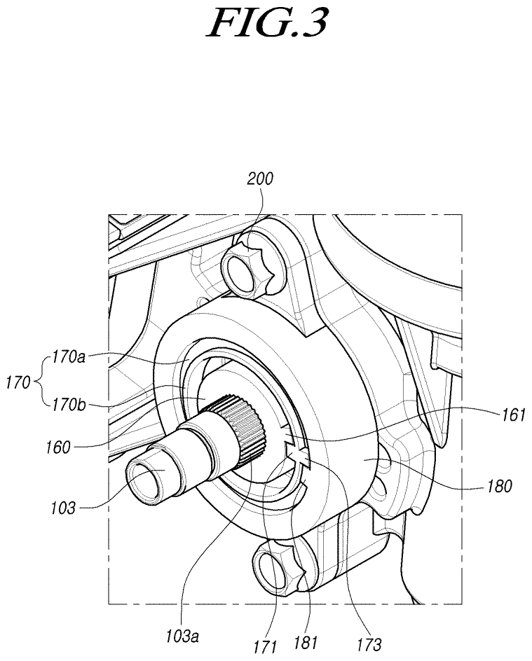

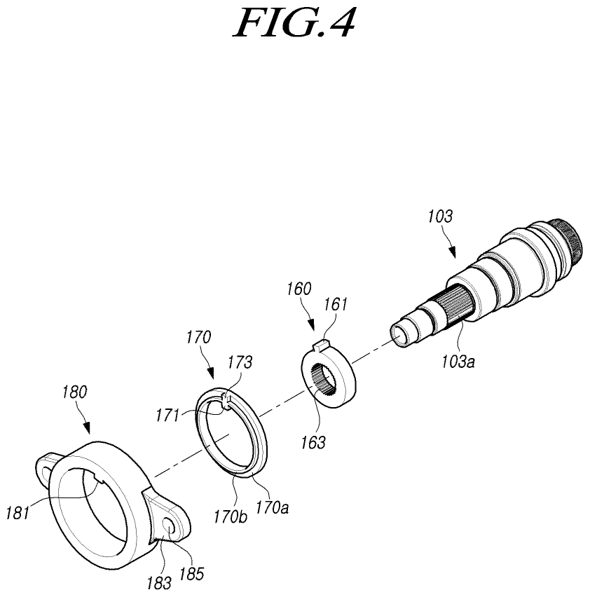

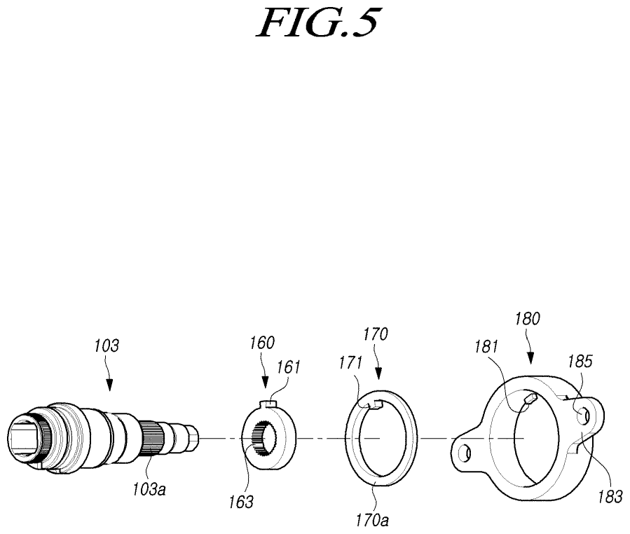

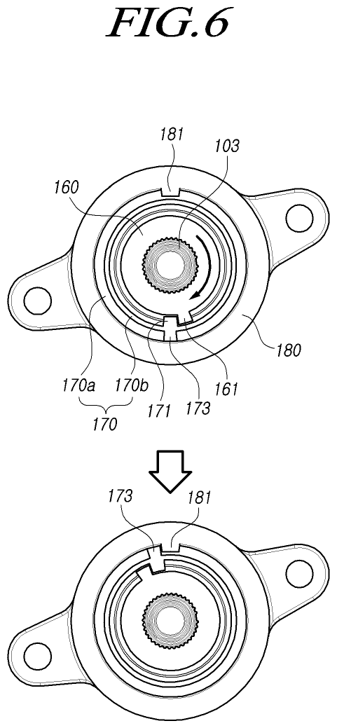

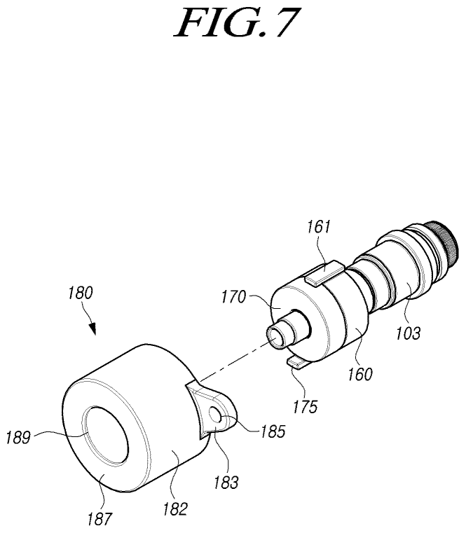

FIG. 1 is a schematic view schematically showing a steer by wire steering system according to the present embodiments. FIGS. 2 and 3 are perspective views showing some of the steer by wire steering system according to the present embodiments. FIGS. 4 and 5 are exploded perspective views showing some of the steer by wire steering system according to the present embodiments. FIG. 6 is a front view illustrating a process in which rotation is restricted in the steer by wire type steering apparatus according to the present embodiments. FIGS. 7 to 10 are exploded perspective views showing some of the steer by wire steering system according to the present embodiments.

As illustrated in FIGS. 1 to 10, a steer by wire type steering apparatus according to the present embodiments include a first rotating member 160 coupled to the steering shaft 103 to rotate in interlocking, a second rotating member 170 supported on the outer periphery of the first rotating member 160 and rotating in conjunction with the first rotating member 160 when the steering shaft 103 rotates, and a housing 180 in which the first rotating member 160 and the second rotating member 170 are built-in, coupled to the steering column 100, and the outer circumferential side of the second rotating member 170 is supported on an inner circumferential surface to restrict rotation of the second rotating member 170.

First, referring to FIG. 1, in the steer by wire type steering apparatus according to the present embodiments, an angle sensor 105 and a torque sensor 107 on one side of a steering shaft 103 connected to a steering wheel 101 is coupled, and the angle sensor 105 and the torque sensor 107 that detect this when the driver operates the steering wheel 101 send electrical signals to the electronic control device 110 to the steering shaft motor 120 and the pinion shaft motor 130 is activated.

The electronic control device 110 controls the steering shaft motor 120 and the pinion shaft motor 130 based on the electrical signals transmitted from the angle sensor 105 and the torque sensor 107 and the electrical signals transmitted from other sensors mounted on the vehicle.

The steering shaft motor 120 is connected to a speed reducer 135 for reducing the number of revolutions of the motor, and provides a reaction force to the steering shaft 103 so as to feel a steering reaction force in the opposite direction when the driver operates the steering wheel 101 during normal driving. And during autonomous driving, steering is performed by the control of the electronic control device 110 without the driver's will.

The pinion shaft motor 130 slides the rack bar 111 connected to the pinion shaft 113 to steer the wheels 119 on both sides through the tie rod 115 and the knuckle arm 117.

However, in the drawings in the present embodiments, for convenience of explanation, the angle sensor 105 and the torque sensor 107 are provided on the steering shaft 103 as an example, but a vehicle speed sensor and a motor position sensor for transmitting steering information to the electronic control device 110, various radars, lidar, image sensors such as a camera, etc. may be provided, and a detailed description thereof will be omitted below.

In such a steer by wire type steering apparatus, since the steering wheel 101 and the wheel 119 are not mechanically connected, when the driver manipulates the steering wheel 101, a mechanical restriction is required to stop the rotation of the steering wheel 101 at a certain angle.

That is, when the rotation of the wheel 119 reaches the maximum point (in a general steering device, when the steering wheel 101 or the wheel 119 is in a full-turn state), the rotation angle limiting member 150 for mechanically limiting the rotation angle of the steering shaft 103 is provided so that the steering wheel 101 is not rotated anymore. Thus, it provides the driver with an accurate steering feeling.

The rotation angle limiting member 150 includes a first rotating member 160 provided at the lower end of the steering column 100 coupled to the steering shaft 103 to rotate in interlocking and coupled to the vehicle body with the mounting bracket 102, a second rotating member 170 supported on the outer periphery of the first rotating member 160 and rotating in conjunction with the first rotating member 160 when the steering shaft 103 rotates, a housing 180 in which the first rotating member 160 and the second rotating member 170 are built in and coupled to the steering column 100 and the outer circumferential side of the second rotary member 170 is supported on the inner circumferential surface to limit the rotation of the second rotary member, etc.

The steering shaft 103 may be formed by connecting two or more shafts, and the first rotating member 160 is coupled to the outer circumferential surface of the steering shaft 103.

Serrations 103a and 163 corresponding to each other are provided on the outer circumferential surface of the steering shaft 103 and the inner circumferential surface of the first rotating member 160, so that when the steering shaft 103 rotates, the output shaft 112 and the first rotating member 160 rotates in conjunction with each other without spinning.

And, the second rotating member 170 built into the housing 180 together with the first rotating member 160 is supported on the outer peripheral side of the first rotating member 160 and the first rotating member 160 and linked and rotated. Then, after the rotation by the predetermined steering angle is made, the second rotation member 170 is supported by the housing 180 and rotation is limited.

That is, the first rotation member 160 is provided with a first support portion 161 protruding in a radial direction on the outer peripheral side, and the second rotating member 170 is provided with a second support portion 171 that protrudes in the radial direction to the inner peripheral side is supported by the first support portion 161 in the circumferential direction.

Accordingly, when the first rotating member 160 is rotated in conjunction with the steering shaft 103, the first support portion 161 of the first rotating member 160 rotates the second rotating member 170 while supporting the second support portion 171 of the second rotating member 170 in the circumferential direction.

As shown in FIGS. 2 to 8, the first rotating member 160 and the second rotating member 170 are coaxially disposed, and the second rotating member 170 is provided on the outer peripheral side of the first rotating member 160, and the inner peripheral surface of the housing 180 is disposed on the outer peripheral side of the second rotating member 170.

The second rotating member 170 is provided with a large diameter portion 170a and a small diameter portion 170b arranged in the axial direction so that the outer peripheral side is stepped, and the inner peripheral surfaces of the large diameter portion 170a and the small diameter portion 170b are formed in a ring shape connected in the axial direction.

Then, on the inner peripheral side of the large diameter portion 170a and the small diameter portion 170b, the second support portion 171 circumferentially supported by the first support portion 161 of the first rotating member 160 is radially protrude.

In addition, the second rotating member 170 is provided with a third support portion 173 protruding in a radial direction on the outer peripheral side of the small diameter portion 170b, and the housing 180 is provided with a fourth support portion 181 that protrudes in a radial direction to the inner peripheral side and is supported by the third support portion 173 in the circumferential direction.

Accordingly, when the second rotation member 170 is interlocked and rotated by the first rotation member 160, the rotation is stopped while the third support portion 173 of the second rotation member 170 is supported by the fourth support portion 181 of the housing 180 in the circumferential direction. And the rotation angle of the steering shaft 103 is limited.

That is, as shown in FIG. 6, when the steering shaft 103 rotates in the clockwise direction, the first rotating member 160 rotates in the clockwise direction. And, when the first support portion 161 is supported by the second support portion 171 in a clockwise direction as shown in the upper drawing of FIG. 6, the second rotation member 170 also rotates in the clockwise direction. And, as shown below in FIG. 6, when the third support portion 173 of the second rotation member 170 is supported by the fourth support portion 181 of the housing 180, all of the steering shaft 103, the first rotation member 160, and the second rotation member 170 stop, and the rotation angle of the steering shaft 103 is limited.

The fourth support portion 181 formed in the housing 180 is radially spaced apart from the small diameter portion 170b and supported by one axial end of the large diameter portion 170a in the axial direction, so that the second rotation member 170 is prevented from being separated to the outside.

The housing 180 is provided with a fastening flange 183 having a fastening hole 185 to be coupled to the steering column 100, and is coupled to the lower portion of the steering column 100 by a fastening member 200.

On the other hand, in the present embodiments, the first support portion 161, the second support portion 171, the third support portion 173, and the fourth support portion 181 are each provided one by one as an example, but It should be noted that the number and position in the circumferential direction may be arbitrarily changed according to the design value of the rotation angle of the steering shaft 103.

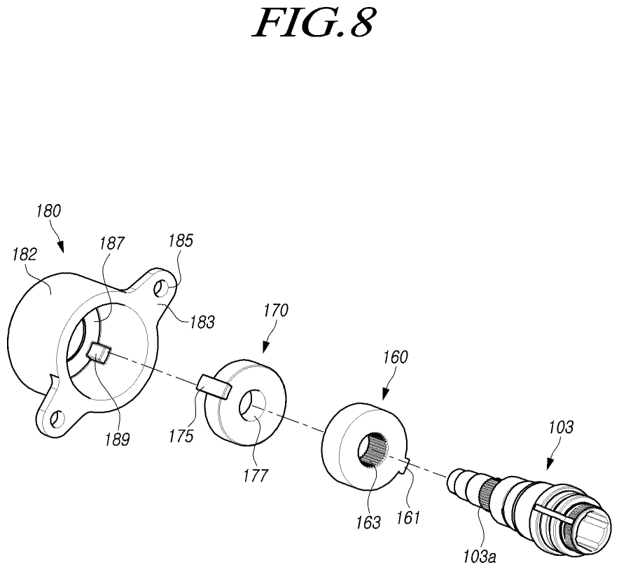

As shown in FIGS. 7 and 8, the first support portion 161 protrudes in the axial direction from one end of the first rotating member 160, and the end is located on the outer periphery of the second rotating member.

And, the second rotation member 170 may be provided with an outer circumferential support portion 175 that protrudes in a radial direction from the outer circumference side and is supported by the first support portion 161 in the circumferential direction.

The first rotating member 160 and the second rotating member 170 are coupled to the steering shaft 103 so as to be disposed adjacent to each other in the axial direction, and the steering shaft 103 and the first rotating member 160 rotate in interlocking manner, and the inner circumferential surface of the second rotating member 170 is rotatably coupled to the outer circumferential surface of the steering shaft 103.

The outer circumferential support portion 175 is formed to protrude from one end and the other end of the second rotating member 170 to both sides in the axial direction, and an inner circumferential support portion 189 that protrudes in a radial direction and is supported in a circumferential direction by the outer circumferential support portion 175 of the second rotating member 170 may be provided on the inner circumferential side of the housing 180.

Here, the first support portion 161 is positioned on the outer peripheral side of the second rotating member 170, one end of the outer peripheral support portion 175 is positioned on the inner peripheral side of the housing 180, and the other end is positioned on the outer peripheral side of the rotating member 160.

Accordingly, when the steering shaft 103 is rotated, the first support portion 161 of the first rotation member 160 is supported in the circumferential direction by the outer peripheral support portion 175 of the second rotation member 170, and the second rotation member 170 is interlocked and rotates, and the outer circumferential support portion 175 is supported by the inner circumferential support portion 189 of the housing 180 in the circumferential direction to stop the rotation and the rotation angle of the steering shaft 103 is limited.

In addition, a partition wall 187 extending radially from the hollow cylinder part 182 is formed at one end of the housing 180, and the partition wall 187 is provided with a through hole 189 through which the steering shaft 103 passes.

Accordingly, the partition wall 187 of the housing 180 supports the outer circumferential support portion 175 of the second rotation member 170 coupled to the steering shaft 103 in the axial direction to prevent the separation of the second rotation member 170.

The housing 180 is provided with a fastening flange 183 having a fastening hole 185 to be coupled to the steering column 100 and is coupled to the lower portion of the steering column 100 by a fastening member.

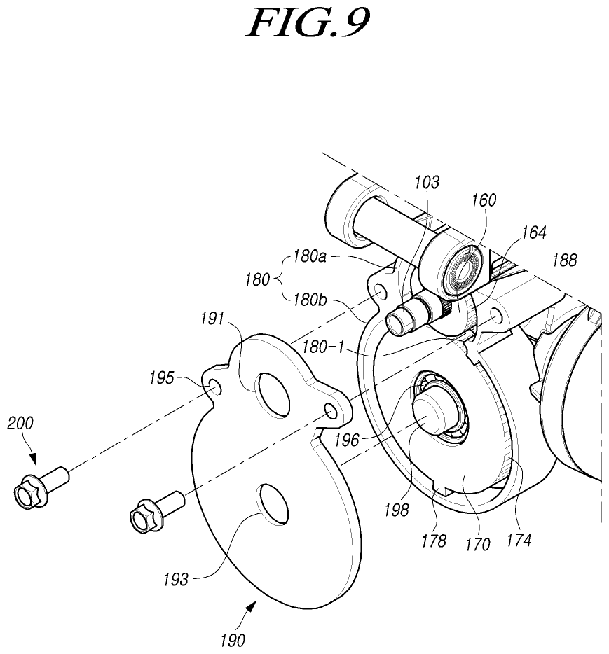

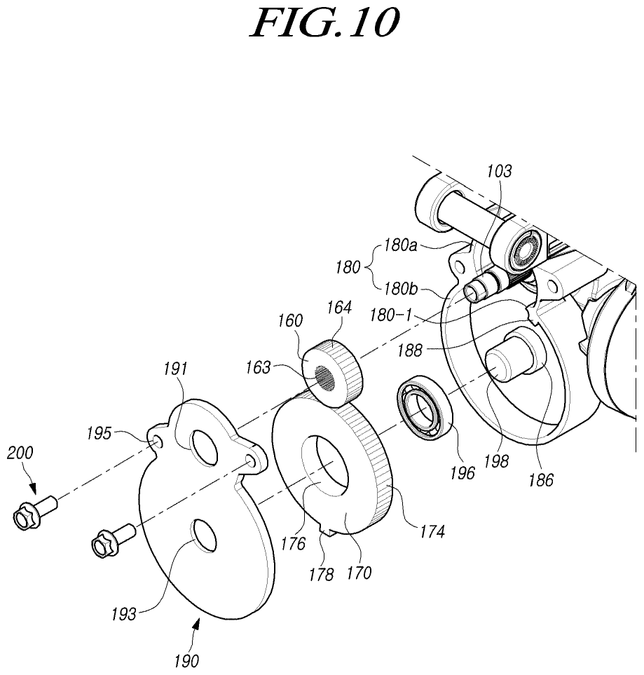

In addition, as shown in FIGS. 9 and 10, a first gear portion 164 is formed on the outer peripheral side of the first rotating member 160, and a second gear portion 174 that meshes with the first gear portion 164 of the first rotation member 160 is formed on the outer peripheral side of the second rotation member 170. Accordingly, when the steering shaft 103 is rotated, the first gear portion 164 and the second gear portion 174 may be interlocked to rotate.

In this case, the central axis of the first rotating member 160 and the second rotating member 170 is disposed parallel to each other so that the first gear portion 164 and the second gear portion 174 can mesh.

The housing 180 is provided with a support shaft 198 spaced apart from the steering shaft 103, a coupling hole 176 to which the support shaft 198 is coupled is provided in the center of the second rotation member 170. And a shaft coupling portion 186 protruding in the axial direction to insert and support the support shaft 198 is formed inside the housing 180.

Here, the support shaft 198 and the shaft coupling portion 186 may be integrally formed with the housing 180.

In addition, a rotation support member 196 is coupled between the support shaft 198 and the coupling hole 176 of the second rotation member 170, so that the rotation support member 196 supports the rotation of the second rotation member 170 which is engaged with the first rotation member 160.

Here, the second rotating member 170 is provided with a rotating protrusion 178 protruding in a radial direction on the outer peripheral side, and the housing 180 is provided with a fixing protrusion 188 that protrudes in a radial direction on the inner circumferential side and is supported in the circumferential direction by the rotating protrusion 178 of the second rotating member 170. Accordingly, when the second rotating member 170 rotates, the rotating protrusion 178 is supported by the fixing protrusion 188 and rotation is limited.

The housing 180 includes a first housing portion 180a in which the first rotation member 160 is embedded and a second housing portion 180b in which the second rotation member 170 is embedded.

The first housing portion 180a and the second housing portion 180b are provided with an opening 180-1 at a position where the first gear portion 164 and the second gear portion 174 are meshed with each other. The first rotation member 160 and the second rotation member 170 are coupled to each other and are built into the first housing portion 180a and the second housing portion 180b.

The fixing protrusions 188 formed on the inner peripheral side of the housing 180 are respectively provided on both sides of the inner peripheral surface of the second housing portion 180b adjacent to the opening 180-1 in the circumferential direction.

In addition, on the outside of the housing 180, a cover member 190 provided with a first through hole 191 through which the steering shaft 103 passes and a second through hole 193 through which the support shaft 198 penetrates is combined to seal the first rotating member 160 and the second rotating member 170, thereby preventing foreign substances from entering the housing 180 from the outside.

The cover member 190 is provided with a fastening hole 195 to be coupled to the housing 180 and is coupled to the housing 180 by the fastening member 200.

As described above, according to the present embodiments, there is provided a steer by wire type steering apparatus that increases a driver's steering feel and steering safety by preventing the steering wheel from mechanically rotating any more when the rotation of the wheel reaches the maximum point.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

1. A steer by wire type steering apparatus, comprising:
a first rotating member coupled to the steering shaft to rotate in interlocking;
a second rotating member supported on the outer periphery of the first rotating member and rotating in conjunction with the first rotating member when the steering shaft rotates; and
a housing in which the first rotating member and the second rotating member are built-in, coupled to the steering column, and the outer circumferential side of the second rotating member is supported on an inner circumferential surface to restrict rotation of the second rotating member;

2. The steer by wire type steering apparatus of claim 1, wherein the first rotating member is provided with a first support portion protruding in a radial direction on the outer peripheral side.

3. The steer by wire type steering apparatus of claim 2, wherein a second support portion protruding in a radial direction and supported in a circumferential direction of the first support portion is provided on an inner peripheral side of the second rotating member.

4. The steer by wire type steering apparatus of claim 2, wherein the second rotating member is formed in a ring shape in which the inner circumferential surface of a large diameter portion and a small diameter portion are axially connected to each other so that the outer circumferential side is stepped in the axial direction, and the second support portion is provided on the inner peripheral side of the large diameter portion and the small diameter portion.

5. The steer by wire type steering apparatus of claim 4, wherein the second rotating member is provided with a third support portion protruding in a radial direction on the outer peripheral side of the small diameter portion.

6. The steer by wire type steering apparatus of claim 5, wherein a fourth support portion protruding radially from the inner peripheral side of the housing and supported by the third support portion in a circumferential direction is provided.

7. The steer by wire type steering apparatus of claim 2, wherein the first support portion is formed to protrude from one end of the first rotating member in the axial direction.

8. The steer by wire type steering apparatus of claim 7, wherein an end of the first support portion is formed to be positioned on an outer peripheral side of the second rotating member.

9. The steer by wire type steering apparatus of claim 8, wherein the second rotating member includes an outer circumferential support portion protruding radially to the outer circumferential side and supported in the circumferential direction by the first support portion.

10. The steer by wire type steering apparatus of claim 9, wherein the outer peripheral support portion is formed to protrude in the axial direction from one end and the other end of the second rotating member.

11. The steer by wire type steering apparatus of claim 10, wherein the outer peripheral support portion is formed to one end is located on the inner peripheral side of the housing and the other end is positioned on the outer peripheral side of the first rotating member.

12. The steer by wire type steering apparatus of claim 11, wherein the housing is provided with an inner circumferential support portion protruding radially to the inner circumferential side and supported in the circumferential direction by the outer circumferential support portion.

13. The steer by wire type steering apparatus of claim 1, wherein a first gear portion is formed on an outer peripheral side of the first rotating member, and a second gear portion meshed with the first gear portion is formed on an outer peripheral side of the second rotating member, so that the first gear portion and the second gear portion are interlocked to rotate when the steering shaft rotates.

14. The steer by wire type steering apparatus of claim 13, wherein the housing is provided with a support shaft spaced apart from the steering shaft, and a coupling hole to which the support shaft is coupled is provided at the center of the second rotating member.

15. The steer by wire type steering apparatus of claim 14, wherein a rotation support member for supporting the rotation of the second rotation member is coupled between the support shaft and the coupling hole of the second rotation member.

16. The steer by wire type steering apparatus of claim 15, wherein the second rotating member is provided with a rotating protrusion protruding in a radial direction on the outer peripheral side of the second rotating member.

17. The steer by wire type steering apparatus of claim 16, wherein the housing is provided with a fixing protrusion protruding radially from the inner circumferential side and supported in the circumferential direction by the rotating protrusion to limit the rotation of the second rotating member.

18. The steer by wire type steering apparatus of claim 17, wherein the housing includes a first housing portion in which the first rotation member is embedded and a second housing portion in which the second rotation member is embedded, and the first housing portion and the second housing portion are provided with an opening at position where the first gear portion and the second gear portion are meshed with each other.

19. The steer by wire type steering apparatus of claim 18, wherein the fixing protrusion is provided on both sides of the inner peripheral surface of the second housing portion adjacent to the opening in the circumferential direction.

20. The steer by wire type steering apparatus of claim 19, wherein a cover member provided with a first through hole through which the steering shaft passes and a second through hole through which the support shaft passes is coupled to the outside of the housing.
